(19) United States
(12) Patent Application Publication
(10) Pub. No.: US 2025/0377940 A1
(43) Pub. Date: Dec. 11, 2025

(54) HARDWARE ACCELERATION FOR GENERATIVE MODELS

(71) Applicant: Microsoft Technology Licensing, LLC, Redmond, WA (US)

(72) Inventor: Ori LASLO, Rehovot (IL)

(21) Appl. No.: 18/739,291

(22) Filed: Jun. 10, 2024

(51) Int. Cl. G06F 9/50; G06F 1/03; G06F 7/22

(52) U.S. Cl. CPC G06F 9/5027; G06F 1/03; G06F 7/22

(57) ABSTRACT

A computing system with hardware acceleration for execution of generative models is provided. The computing system comprises a processor and memory storing instructions that, when executed by the processor, cause the processor to execute a generative model. The computing system further comprises an accelerator module which performs compute operations during execution of the generative model. Prior to execution of the generative model, the accelerator module determines a maximum and minimum value for a functional computation to be performed during execution of the generative model. The accelerator module modifies possible inputs into functional computation to reduce the size of an input value by N bits. The accelerator module performs the functional computation based upon the modified input value, the minimum value, and the maximum value. During execution of the generative model, the accelerator module obtains a value for the functional computation to be used during generation of output of the generative model.

### BACKGROUND

Generative artificial intelligence (AI) models have recently been developed to generate complex outputs based upon structured inputs known as prompts. These models, which include large language models (LLMs), receive a prompt as input and in near real-time (e.g., within a few seconds of receiving the input) generate an output that is responsive to the input prompt. The output generated by the model is often human readable text, but models can also produce output in the form of executable source code, images, music, video, etc. In general, the model processes the input as a sequence of tokens and generates an output based upon a contextual inference of the model. Each successive output token is generated in part based upon its preceding token. The generative model retains the information from each successive input-output sequence which enables a conversational interaction with the model.

The output generated by the generative model is based upon training data over which the generative model has been trained. With “large” models, the number of parameters within the trained model is in the billions. While this enables the generative models to produce sophisticated output based upon large-scale training data, the computing resources required by the computing system executing the generative model are significant. More specifically, the implementation architecture of the generative model contributes to the significant computing resources required at the time of execution of the model.

For example, recent advancements in generative models are largely based upon transformer architecture. Transformers introduced the concept of parallel processing of input tokens as opposed to sequential processing as was used in conventional natural language processing (NLP) technologies. Transformer-based models perform such parallel processing of input tokens by way of a concept known as attention. Attention enables the model to determine parts of an input sequence that are more likely to be significant in generating accurate and responsive output, and thus more “attention” can be applied by the model during output generation. The attention mechanism also enables generative models to handle larger input lengths while still generating an accurate output.

Generative models that employ the transformer architecture and the associated attention mechanism are reliant on the frequent computation of a mathematical function known as the softmax function. The softmax function is a normalization function that can distinguish between “strong” and “weak” dimensions in a vector. For example, the softmax function receives an input vector and outputs a new vector with the same length, for which the sum of the elements is equal to 1. Large values in the input vector will correspond to large values in the output vector and vice versa. Typically, small differences between elements in the input vector will be amplified in the output vector. These aspects of the softmax function are applied by generative models in both the attention block and in the linear output layer of transformer-based generative models, meaning that the softmax function must be calculated many times for each inference of the generative model.

Due to the frequency that the softmax computation is required for execution of a generative model, optimization of the computing system executing the model and performing the computations can reduce the operational latency of the model which reduces the overall computational resources consumed by the computing system.

### SUMMARY

The following is a brief summary of subject matter that is described in greater detail herein. This summary is not intended to be limiting as to the scope of the claims.

Various technologies pertaining to hardware acceleration for execution of a generative model are described herein. It is a general aspect of generative models that the models require substantial computing resources to execute, specifically at inference time when the model is generating the next output token. A significant component of the computing resource requirements for generative models is the computationally intensive softmax function. Computation of the softmax function is required in the attention block and in the linear output layer of transformer-based generative models, meaning that computation of the softmax function is required multiple times for each inference iteration of the model.

Conventionally, computing systems executing generative models are scaled up to include greater hardware resources to accommodate the computational demands of the model. As demand for generative model resources and model complexity increase, scaling the computing system hardware resources to accommodate execution of the models becomes impractical or impossible. In one conventional approach, computational optimization involves quantization, or compressing input values to use a smaller number of bits. For example, quantizing may reduce the data precision format used by the model (e.g., from floating point 32 (FP32) to floating point (FP16)). While quantization reduces the size, latency, and computational demand of the model, further optimization may be realized through improved computational architecture.

In an aspect of the technologies described herein, computation of the softmax function can be optimized by way of a hardware accelerator configured to efficiently compute components of the softmax function; more specifically, the numerous exponent function calculations required for each softmax computation. The hardware accelerator therefore reduces the total resources required for each computation of the softmax function during execution of a generative model at interference time. By employing the hardware accelerator architecture described herein, computational operations executed by a computing system processor (e.g., central processing unit (CPU), graphics processing unit (GPU), neural processing unit (NPU), etc.) are executed more efficiently, reducing overall consumption of computational resources and reducing latency during execution of a generative model.

Certain functionality of the technologies described herein are illustrated through the following examples. In a first example, a computing system comprising a processor and a memory is described. The memory stores instructions that, when executed by the processor (e.g., CPU, GPU, NPU, etc.), cause the processor to execute a generative model, wherein the generative model receives an input and generates an output responsive to the input. In some examples, the generative model is a transformer-based large language model (LLM). The computing system further comprises an accelerator module configured to perform compute operations during the execution of the generative model.

Prior to the generative model receiving an input, the accelerator module performs certain compute operations. In an example, the accelerator module performs a functional computation for a range of input values and maintains the results in a lookup table. In some examples, the lookup table is stored in memory. In another example, the lookup table is hardwired in hardware of the computing system. At inference time of the generative model, computed values for a functional computation can be retrieved from the lookup table instead of computed at runtime. The accelerator module logically reduces the number of possible input values resulting in a reduced number of corresponding output values in the lookup table. The accelerator module additionally improves the operational latency of the model as obtaining values from the lookup table for a frequently computed function is faster than computing the function at runtime.

The accelerator module reduces the number of possible input values for a functional computation by determining a minimum and maximum input value for the functional computation. In an example, the functional computation is an exponent multiplication function (e.g., f(x)=e^{x}). Improving the computational latency of exponent multiplication can effectively reduce the computational latency of other functional computations which require significant exponent multiplication, such as the softmax function.

In many generative models, certain values (e.g., model weights and activation vectors) are quantized to improve latency and reduce the computational resources required to execute the generative model. For quantized values, the hardware accelerator module can further reduce the computational resources required to perform calculations using the quantized values by determining maximum and minimum bounds of the computed values. For example, for a given data precision format, there are certain input values that will result in the same repeated calculated output value (e.g., rounded to zero or infinity/overflow) for input values above a maximum value and input values below a minimum value.

To determine the maximum value for the functional computation, the accelerator module determines the boundary input value for the functional computation that will result in the output of a repeated special value (e.g., negative infinity, zero, or positive infinity) for values greater than the maximum value. For example, a maximum value may be an input value to the functional computation that results in a value of infinity for all values exceeding the maximum value (e.g., a data overflow calculation for the given data precision format). In an example, for a data precision format of brainfloat 16 (BF16), an input value is a 16 bit floating point value, represented by 1 sign bit (positive or negative), 8 exponent bits, and 7 mantissa (fraction) bits. So when the functional computation is an exponent multiplication function (e.g., f(x)=e^{x}) in BF16, the maximum value x for the functional computation is approximately 88.7, because the maximum positive value represented in BF16 is approximately 3.39*10³⁸ and e^{88.7} is approximately equal to 3.3*10³⁸. Values greater than 88.7 will result in an overflow calculation because the number exceeds the maximum value for BF16. The value is “repeated” because for all values greater than the maximum value the same output value is computed. In an example, in a lookup table generated by the accelerator module, output values corresponding to input values greater than the maximum value will be the same, allowing the accelerator module to reduce the values greater than the maximum value to a single stored value (e.g., negative infinity, zero, or positive infinity). Similarly, for minimum values, the same output value is computed for input values less than the minimum value, allowing the accelerator module to reduce the possible input values by assigning a single value (e.g., in a lookup table) to values less than the minimum value.

To determine the minimum value for the functional computation, the accelerator module determines the boundary input value for the functional computation that will result in the output of a repeated special value (e.g., negative infinity, zero, or positive infinity) for values less than the minimum value. For example, a minimum value may be an input value to the functional computation that results in an output value that will be rounded to zero for all values less than the minimum value. Continuing with the above example, for an exponent multiplication function in BF16, the minimum value x for the functional computation of ex is approximately −87, because the minimum positive value represented in BF16 is approximately 1.175*10⁻³⁸ and e⁻87 is approximately equal to half the minimum positive value, meaning values less than −87 will be rounded to zero.

Accordingly, for the functional computation of e^{x} in data precision format BF16, only values in the range [˜−87, ˜88.7] will result in an output that is not zero or infinity. It is appreciated that other data precision formats and/or functional computations may have slightly different minimum and maximum values, but for all quantized data precision formats, there exists boundaries that will exceed the representative capacity of the data precision format and result in a repeated calculation of zero or infinity for values beyond the boundary.

Upon determining the maximum and minimum values for the functional computation based upon the data precision format, the accelerator module modifies an input value for the functional computation to reduce the size of the input value by N bits, wherein N is a positive integer. For example, for a BF16 data precision format, the input value would be 16−N bits in length. If N=3, an exemplary input value would be represented in 13 total bits including 1 sign bit, 8 exponent bits, and 4 fraction bits, where 3 of the least significant bits are ignored. In an example, the accelerator module reduces the size of the input value by assigning a fixed value to N bits of the input value. The value of N may be varied by the accelerator module based upon an accuracy tolerance for the generative model. As N increases, the size and latency of the model are reduced while the model may become less accurate. In some examples, N can be varied according to a parameter of the generative model, wherein N can be increased if a high degree of accuracy is not required, thereby improving the latency of the model. By reducing the size of the input value by N bits the total number of corresponding output values also decreases.

After determining maximum and minimum values for the functional computation, the accelerator module then performs the functional computation based upon the modified input value, the minimum value, and the maximum value. In some examples the accelerator module uses compute logic to perform the functional computation. For example, the compute logic may comprise a multiplexor array. The multiplexor array comprises a plurality of multiplexors operable to logically determine an output value for every bit for a given data precision format number based upon received control bits.

The result values of the functional computation (e.g., as determined by way of the compute logic) can be stored in a lookup table. The lookup table may be generated by the accelerator module, for example, using compute logic comprising a multiplexor array. In some examples, the lookup table is hardwired in embedded compute logic.

Continuing with the above example, for an exponential function in BF16 data precision format, when N=3, an exemplary multiplexor array has 16−N control bits to represent the BF16 input number with its modified value (e.g., reduced by N bits). Each multiplexor in the multiplexor array has hardwired inputs of 0 and 1 (e.g., ground or V_{dd}), which results in a 15 bits output (the sign bit will always be 0 because the exponential function is never negative). Because the accelerator module determined the maximum and minimum input boundaries and further reduced the input value by N bits, fewer unique values are stored in the lookup table, reducing the size of the lookup table and increasing the speed at which values may be extracted from the lookup table when a computation of a function is required during execution of the generative model. For some functional computations, the sign bit may also be fixed when the function can only have positive or negative output values.

Responsive to the generative model receiving an input, the accelerator module obtains values for the functional computation to be used during generation of the output of the generative model (e.g., by way of the lookup table). As mentioned above, by generating output values and storing the values in a lookup table, the accelerator module improves the operational latency of the model because obtaining values from the lookup table for a frequently computed function is faster than computing the function at runtime. Moreover, the resultant lookup table generated by the accelerator module comprises far fewer entries than a full data precision lookup table, consuming less space and achieving faster performance at runtime.

An exemplary computing system implementing the described accelerator module offers several advantages over conventional technologies when implementing a generative model. For example, the accelerator module results in faster performance of the generative model through efficient computation of certain functions (e.g., exponential functions) required during execution of the generative model. Additionally, the accelerator module reduces the overall size of the hardware implementation of the accelerator module, which further increases efficiency of the computing system executing the model.

While generally described with respect to an exponent multiplication function, the technologies described herein have further advantageous implications in all functional computation contexts, specifically where reduction of accuracy of the computation (e.g., through reduction of data precision beyond quantization) is negligible in production of generative model output and/or when performance of the model and reduction in consumption of computational resources is a priority.

The above presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an example computing system.

FIG. 2A is an exemplary representation of a BF16 data precision format value.

FIG. 2B is an exemplary representation of a modified BF16 data precision format value.

FIG. 3 is a functional block diagram illustrating an exemplary multiplexor array.

FIG. 4 is a flow diagram that illustrates an example methodology for hardware acceleration of generative models.

FIG. 5 depicts an example computing device.

Various technologies pertaining to hardware acceleration for execution of generative models as described herein are now described with reference to the drawings, wherein like reference numerals are used to refer to like elements throughout.

In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

### DETAILED DESCRIPTION

As noted above, computing systems executing generative models require substantial computational resources, especially at model inference time. In many cases, scaling the computing system resources to match the demand and complexity of the model is impractical or impossible, so optimization of the computing system for the purposes of execution of generative models is needed to compensate for the demand on computational resources by the generative model. The technologies described herein are directed towards a hardware acceleration module that facilitates efficient computation of functions that are frequently computed during execution of a generative model (e.g., exponential function f(x)=e^{x}). By more efficiently computing such functions, the generative model will realize improvement in runtime latency which reduces the overall consumption of computational resources required to execute the generative model.

Generative models require substantial computing resources partly due to the frequent computation of the softmax function. The softmax function is shown in equation 1:

$${σ ( z )}_{i} = \frac{{e}^{{z}_{i}}}{{\sum }_{j = 1}^{K} {e}^{{z}_{j}}} for i = 1 , … , K and z = ( {z}_{1} , … , {z}_{K} ) ∈ {ℝ}^{K} \qquad ( 1 )$$

The softmax function o of input vector z is computed by calculating the exponential function for each element of the input vector and dividing by the sum of each of the exponential values. The softmax function is a normalization function that can distinguish between “strong” and “weak” dimensions in a vector. For example, the softmax function receives an input vector and outputs a new vector with the same length, for which the sum of the elements is equal to 1. Large values in the input vector will correspond to large values in the output vector and vice versa. Typically, small differences between elements in the input vector will be amplified in the output vector. These aspects of the softmax function are applied by generative models in both in the attention block and in the linear output layer of transformer-based generative models, meaning that the softmax function must be calculated many times during for each inference of the generative model. For example, in the attention block, the softmax function is used to compute attention for the query (Q), value (V), and key (K) vectors according to equation 2:

$$Attention ( Q , K , V ) = soft max ( \frac{{QK}^{T}}{\sqrt{{d}_{k}}} ) V \qquad ( 2 )$$

In the linear output layer of transformer-based generative models, softmax is again used to convert output scores of the model into probabilities (e.g., the sum of the values equals 1). The frequent computation of the softmax function requires significant computing resources to execute. By optimizing certain functional computations (e.g., exponent multiplication) required by the softmax function, the technologies described herein improve upon an exemplary computing system executing a generative model 1) reducing overall consumption of computational resources by the computing system executing the generative model, 2) reducing operational latency of the model, and 3) reducing the silicon area footprint of the computing system executing the generative model.

Various technologies pertaining hardware acceleration for execution of generative models as described herein are now described with reference to the drawings.

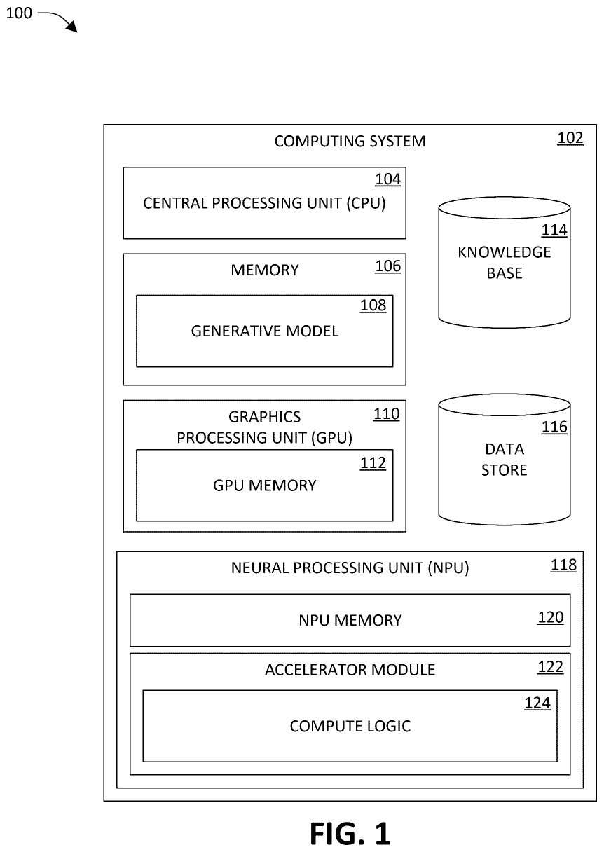

With reference to FIG. 1, an example computing environment 100 is illustrated. The computing environment 100 includes a computing system 102. According to some embodiments, the computing system 102 is a server computing device. According to other embodiments, the computing system 102 is a cloud-based computing platform. While computing system 102 is depicted as a single computing system, it is appreciated that computing system 102 and its components may be a distributed computing system comprising a plurality of computing systems operably connected over a network (e.g., Internet, intranet, etc.) and configured to collectively perform the functionality of computing system 102.

The computing system 102 includes a central processing unit (CPU) 104, a memory 106, a graphics processing unit (GPU) 110, and a neural processing unit (NPU) 118. CPU 104, GPU 110, and NPU 118 may be collectively referred to herein as processors of computing system 102. CPU 104, GPU 110, and NPU 118 may each include one or more processor cores to process computer-executable instructions, such that, when executed, cause the processor to perform certain functionality as described with reference to computing system 102. Depending on the application, CPU 104, GPU 110, NPU 118 (or some combination thereof), may be suitable for executing such instructions. In some examples, CPU 104, GPU 110, and NPU 118 may execute different sets of instructions and perform operations of computing system 102 concurrently or substantially concurrently.

The memory 106 can be a dynamic random access memory (DRAM) device, a static random access memory (SRAM) device, flash memory device, phase-change memory device, or some other memory device suitable to serve as process memory. In some examples, the memory 106 stores instructions, that when executed by a processor (e.g., CPU 104, GPU 110, and/or NPU 118), cause the processor to perform certain operations and/or functionalities associated with computing system 102 and and/or its component parts. More specifically, memory 106 comprises instructions for executing a generative model 108. The generative model 108 may be executed by CPU 104, GPU 110, and/or NPU 118. In an example, GPU 110 additionally has a dedicated GPU memory 112. In another example, NPU 118 has a dedicated NPU memory 120. GPU memory 112 and NPU memory 120 may be any such memory device suitable to serve as process memory and in some examples, may be memories optimized for particular operations performed by GPU 110 and NPU 118. In some examples, memory 106 may be shared among processors of computing system 102 (e.g., CPU 104, GPU 110, and/or NPU 118)). Generative model 108 may be embodied as instructions stored in shared system memory (e.g., memory 106), dedicated GPU memory 112, and/or dedicated NPU memory 120, such that, when executed by the processors cause one or more of the processors to perform the described functionalities of computing system 102.

In an example, the generative model 108 is a transformer-based large language model (LLM) such as, for example, Bidirectional Encoder Representations from Transformers (BERT), Generative Pre-trained Transformer (GPT), or Large Language Model Meta AI (LLaMa). While generally discussed herein in the context of LLMs, it is appreciated that the computing system 102 may be utilized in connection with any generative model where optimization of functional computation is desirable.

The generative model 108 is trained upon training data stored in knowledge base 114. Knowledge base 114 may be communicatively coupled over a network to additional data storage(s) storing data used to train the generative model 108. Computing system 102 further comprises data store 116 which is a non-volatile storage for use in connection with computing system 102.

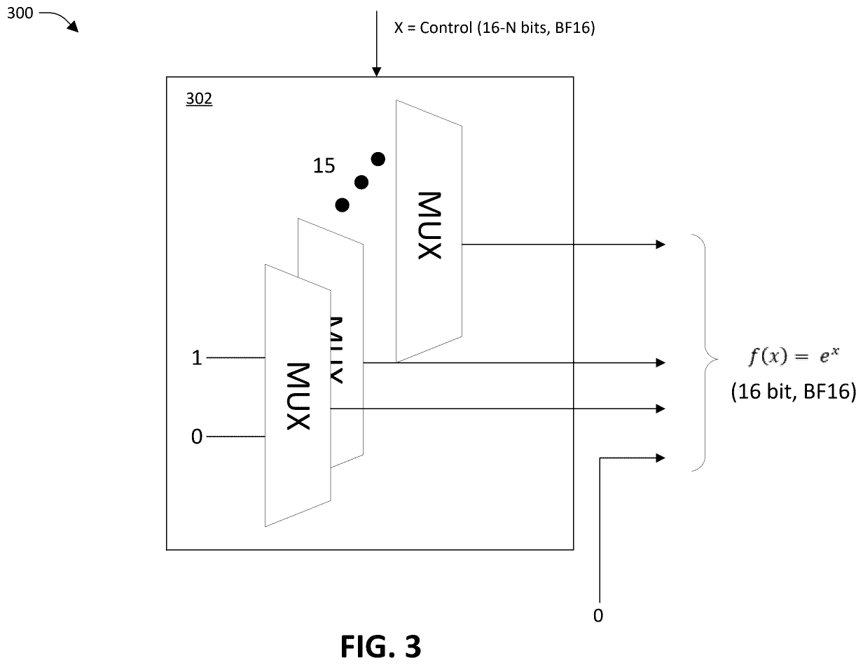

Computing system 102 further comprises an accelerator module 122. The accelerator module 122 executes certain compute operations in connection with execution of generative model 108. As will be described in more detail herein, the accelerator module 122 enhances the performance of the computing system 102 through various computational functions which reduce latency of the generative model 108 at inference time and further reduce the size and overall hardware implementation footprint of the computing system 102. The acceleration module 122 additionally comprises compute logic 124. In some examples, the accelerator module 122 executes compute operations associated with execution of the generative model 108 by way of compute logic 124. In an example, compute logic 124 comprises a multiplexor array, which is described in more detail in FIG. 3. In an example, accelerator module 122 may be embodied as embedded digital logic within computing system 102. In some examples, accelerator module 122 may comprise a set of computer-executable instructions, that when executed by a processor of computing system 102 (e.g., CPU 104, GPU 110, and/or NPU 118), cause the computing system to perform the functionalities of accelerator module 122.

As will be described in greater detail below, the computing device 102, by way of accelerator module 122, is generally configured to (1) determine a maximum value for a functional computation based upon a data precision format; (2) determine a minimum value for a functional computation based upon the data precision format; (3) modify an input value for the functional computation to reduce the size of the input value by N bits; (4) perform the functional computation based upon the modified input value, the minimum value, and the maximum value; and (5) responsive to a generative model receiving an input, obtain a value for the functional computation to be used during generation of the output of the generative model. Execution of the above acts improves the performance of the generative model executed by computing device 102 by reducing latency and overall consumption of computational resources during execution of a generative model (e.g., generative model 108).

In exemplary operation, the computing system 102 is configured to execute a pre-trained generative model, generative model 108. In some examples, the generative model 108 is a transformer-based LLM. The generative model 108 is trained upon data obtained from knowledge base 114. Generative model 108 is configured to receive an input (e.g., an input set forth by a user of a client computing device in network communication with computing system 102) and generate a responsive output based upon the input.

During execution of generative model 108, accelerator module 122 performs certain compute operations associated with execution of the generative model 108 (e.g., computing softmax functions). In an example, responsive to the generative model 108 receiving an input, the accelerator module 122 obtains a value for a functional computation to be used in generation of the output of generative model 108. In one example, the accelerator module 122 obtains the value for the functional computation by extracting the value from a lookup table. A lookup table is a data array which maps possible input values to approximate output values. In some examples, the accelerator module 122 generates a lookup table using compute logic 124. In an example, the lookup table may be stored in a memory of computing system 102. In another example, the lookup table is logically hardwired. During execution of the generative model 108, computed values from the lookup table can be retrieved by accelerator module 122 instead of computed at runtime. The accelerator module improves the operational latency of the generative model 108 because obtaining values from the lookup table for a frequently computed function is faster than computing the function at runtime.

For certain data precision formats, using a lookup table is prohibitive because the number of values in the lookup table is large and requires substantial resources (e.g., memory, large digital logic design, etc.) to retain the lookup table. The accelerator module improves the efficiency of the lookup table by logically reducing the number of possible functional computation input values which results in a reduced number of corresponding output values in the lookup table.

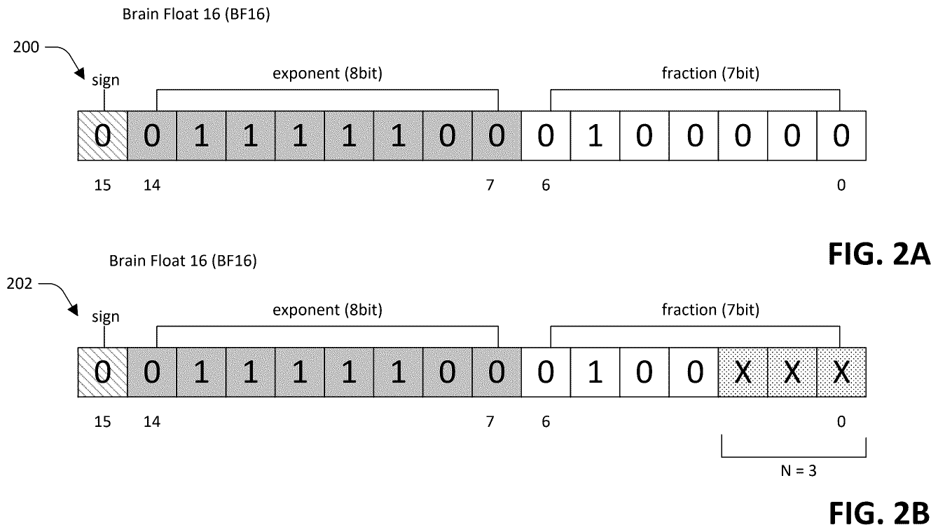

With reference to FIGS. 2A and 2B, an exemplary input value 200 in a data precision format brainfloat 16 (BF16) is illustrated. As used herein, data precision format refers to a computer number format that describes a value in a series of bits as it is understood by the computing system (e.g., computing system 102). Exemplary data precision formats are floating point 32 (expressed as a 32 bit floating point value), floating point 16 (expressed as a 16 bit floating point value), brainfloat 16 (expressed as a 16 bit floating point number with a floating radix point), and many others.

In FIG. 2A, an exemplary input value is a 16 bit BF16 value with 1sign bit, 8 exponent bits, and 7 mantissa (fraction) bits. Since there are 16 bits, there are approximately 65536 possible values that can be represented by the BF16 data precision format (e.g., two possible values for each bit (0 or 1), or 216 possibilities). The accelerator module 122 first reduces the number of possible input values for a functional computation by determining a minimum and maximum input value for the functional computation based upon the data precision format used by the generative model. In an example, the functional computation is an exponent multiplication function (e.g., f(x)=e^{x}). Improving the computational latency of exponent multiplication can effectively reduce the computational latency of other functional computations which require significant exponent multiplication, such as the softmax function.

For a given data precision format, there are certain values that will result in a repeated calculated value (e.g., rounded to zero or positive or negative infinity) when applied to a functional computation. The value is “repeated” because for all values greater than the maximum value the same output value is computed. Similarly, for minimum values, the same output value is computed for input values less than the minimum value.

To determine the maximum value for the functional computation, the accelerator module 122 determines the boundary input value that will result in the same calculated value (e.g., rounded to zero or positive or negative infinity) for values greater than the maximum value. For example, for data precision format BF16 as illustrated in FIG. 2A, the maximum value x for an exponential functional (e.g., f(x)=e^{x}) computation is approximately 88.7, because the maximum positive output value represented in BF16 is approximately 3.39*10³⁸ and e^{88.7} is approximately equal to 3.3*10³⁸. Values greater than 88.7 in the exponential function will result in an overflow calculation because the output number exceeds the maximum value for BF16. Accordingly, when performing a functional computation during execution of a generative model, the accelerator module 122 does not need to compute values over the determined maximum value because it has already been determined to be an infinity/overflow value.

To determine the minimum value for the functional computation, the accelerator module determines the boundary input value for the functional computation that will result in the same calculated value (e.g., rounded to zero or positive or negative infinity) for values less than the minimum value. In an example, values less than the minimum value will result in an output that will be rounded to zero. Continuing with the above example, for an exponent multiplication function in BF16, the minimum value x for the functional computation of e^{x} is approximately −87, because the minimum positive value represented in BF16 is approximately 1.175*10⁻³⁸ and e⁻⁸⁷ is approximately equal to half the minimum positive value, meaning values less than −87 will be rounded to zero.

Accordingly, for the functional computation of ex in data precision format BF16, only values in the range [˜−87, ˜88.7] will result in an output that is not zero or infinity. It is appreciated that other data precision formats may have slightly different minimum and maximum values, but for all quantized data precision formats, there exists boundaries that will exceed the representative capacity of the data precision format and result in a repeated calculation of zero or infinity (positive or negative) for values beyond the boundary. These bounded values do not need to be computed at runtime of the generative model 108 and can be represented in the lookup table by a single value.

As illustrated in FIG. 2B, upon determining the maximum and minimum values for the functional computation based upon the data precision format, the accelerator module 122 modifies an input value 202 for the functional computation to reduce the size of the input value by N bits. N is a non-zero positive integer reflective of a functional reduction of the number of bits (precision) of the input value. For example, for a BF16 data precision format, the input value as reduced by the accelerator module 122 would be 16−N bits in length.

As shown in FIG. 2B, when N=3, the exemplary input value 202 would be represented in 13 bits, 1 sign bit, 8 exponent bits, and 4 fraction bits, where 3 of the least significant bits are reduced. In some examples, the accelerator module 122 reduces the size of the input value by assigning a fixed value to N bits of the input value (e.g., an arbitrary middle value). The value of N may be varied by the accelerator module based upon an accuracy tolerance for the generative model. As N increases, the latency of the model is reduced while the model may become less accurate. By reducing the size of the input value by N bits the total number of corresponding output values also decreases. A reduction in the accuracy of the functional computation will not greatly affect the overall accuracy of the generative model.

Continuing with the above example of an exponent functional computation in BF16 data precision format and N=3, the accelerator module 122 can generate a lookup table with 4238 possible input values corresponding to 4238 output values (4236 unique values+zero+infinity). The significant reduction from 65536 possible values represented by the BF16 data precision format to the 4238 possible values in the lookup table enables the accelerator module 122 to quickly obtain computed values for the exemplary exponential function (e.g., during execution of the generative model 108). Reducing the number of unique values that are stored in the lookup table reduces the size of the lookup table and increases the speed at which values may be extracted from the lookup table when a computation of a function is required during execution of the generative model.

FIG. 3 illustrates exemplary compute logic 300 comprising a multiplexor array 302. The multiplexor array 302 comprises a plurality of connected multiplexors, wherein each multiplexor (also referred to as “mux”) corresponds to one bit of an output value for a functional computation. As illustrated in FIG. 3, the functional computation is an exponential function, f(x)=e^{x} and the data precision format is BF16. Accordingly, for the example exponential function, the output sign bit is a fixed 0, because the output of the exponential function is always non-negative. This results in a multiplexor array 302 comprises 15 connected multiplexors corresponding to the remaining 15 bits of a BF16 output value. In some examples, each multiplexor in the multiplexor array 302 may be a complex multiplexor comprising a plurality of simple multiplexors and/or additional logic. As N is increased the complexity of the synthesized multiplexor array 302 is reduced which reduces the physical area in silicon of the embedded logic.

The inputs of each multiplexor in the multiplexor array 302 are fixed logical 1 and 0 (e.g., ground or V_{dd}). The control bit of each multiplexor in the multiplexor array 302 corresponds to an input value. For example, when the accelerator module 122 reduces a BF16 input value by N bits, the multiplexor array 302 comprises 16−N control bits representing the BF16 input number without its N mantissa least significant bits. The multiplexor array 302 enables logical determination of the exponential function based upon the input value. The output determined by the multiplexor array 302 may be retained by accelerator 122 as a lookup table. Values from the lookup table may then be extracted (e.g., by accelerator module 122) during execution of the generative model instead of performing the computation at runtime. As described herein, the accelerator module 122 logically reduces the possible input values into the multiplexor array 302, which reduces the total possible output values of the computed function and the total area of the resultant lookup table. In an example, for exponent functional computation in BF16 data precision format and when N=3, the accelerator module 122 can generate a lookup table (e.g., by way of multiplexor array 302) with 4238 possible input values corresponding to 4238 output values (4236 unique values+zero+infinity).

In some examples, the accelerator module 122 executes a functional computation using alternative compute logic 124 (e.g., other than multiplexor array 302) such as, for example, a Taylor series approximation using arithmetic logic (e.g., adders and multipliers). However, multiplexor array 302 occupies less area than comparable arithmetic logic and performs computations with less latency. For example, compute logic 124 using multiplexor array 302 can complete an exponential function operation within a single processor clock cycle, even at high clock frequencies. This enables an increase of the total throughput of the accelerator module 122 and increases inference rate during execution of the generative model 108.

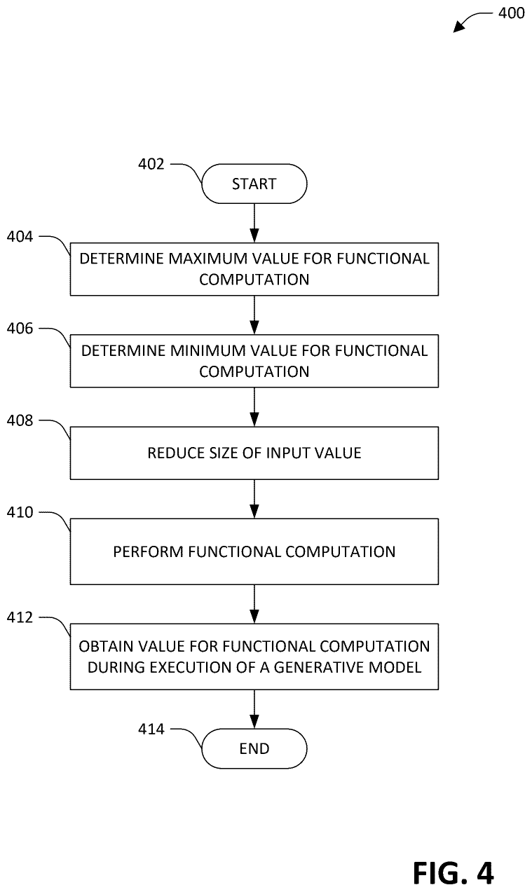

FIG. 4 illustrates an example methodology relating to hardware acceleration for generative models. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement the methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodology can be stored in a computer-readable medium, displayed on a display device, and/or the like.

Referring now to FIG. 4, an example methodology 400 for hardware acceleration for generative models is illustrated. The methodology starts at step 402. At step 404, a maximum value for a functional computation is determined (e.g., by way of accelerator module 122). The maximum value is a boundary input value that will result in a repeated calculated value (e.g., rounded to zero or positive or negative infinity) for values greater than the maximum value. In some examples, the maximum value is based upon a computational maximum for a given data precision format (e.g., FP16, BF16, etc.). For example, the maximum value BF16 is representative of a specific input value where the resultant computed output value for the functional computation would exceed the capacity for representation in the given data precision format and be computed as an infinity value (or overflow).

At step 406, a minimum value for a functional computation is determined (e.g., by way of accelerator module 122). The minimum value is the boundary input value for the functional computation that will result in a repeated calculated value (e.g., rounded to zero or positive or negative infinity) for values less than the minimum value. In some examples, the minimum value is based upon a computational minimum for a given data precision format (e.g., FP16, BF16, etc.) For example, the minimum value is representative of the boundary input value for the functional computation that will result in an output value that will be rounded to zero (e.g., half of the minimum positive value expressed by the data precision format).

At step 408, the size of the input value is reduced, for example, by assigning a fixed value to N number of bits such that N least significant bits of the input value can be computationally ignored. For example, for a BF16 data precision format, the input value would be 16−N bits in length. In an example where N=3, an exemplary input value would be represented in 13 total bits including 1 sign bit, 8 exponent bits, and 4 fraction bits, where 3 of the least significant bits are ignored. The value of N may be varied (e.g., by the accelerator module) based upon an accuracy tolerance of the generative model. As N increases, the latency of the model is reduced while the model may become less accurate. In some examples, N can be varied according to a parameter of the generative model, wherein N can be increased if a high degree of accuracy is not required, thereby improving the latency of the model. By reducing the size of the input value by N bits the total number of corresponding output values (e.g., in a lookup table) also decreases.

At step 410, the functional computation is performed based upon the reduced input value, the minimum value, and the maximum value. In some examples the accelerator module 122 uses compute logic 124 to perform the functional computation. For example, the compute logic 124 may comprise a multiplexor array (e.g., multiplexor array 302). The multiplexor array comprises a plurality of multiplexors operable to logically determine an output value for a functional computation based upon received control bits. In some examples, results of the functional computation are stored in a lookup table. The lookup table may be generated by the accelerator module 122, for example, using compute logic 124 comprising a multiplexor array (e.g., multiplexor array 302).

At step 412, a value for the functional computation is obtained during execution of a generative model (e.g., generative model 108). In an example, the value for the functional computation is extracted from a lookup table (e.g., as generated by the accelerator module 122). By generating output values and storing the values in a lookup table prior to execution of the generative model, the accelerator module improves the operational latency of the model by replacing a computationally expensive runtime compute function with an extraction from the lookup table. Moreover, because the lookup table generated by the accelerator module comprises far fewer entries than a full data precision lookup table, the lookup table is smaller in implementation and enables faster performance of the generative model at runtime. At step 414, the methodology 400 ends.

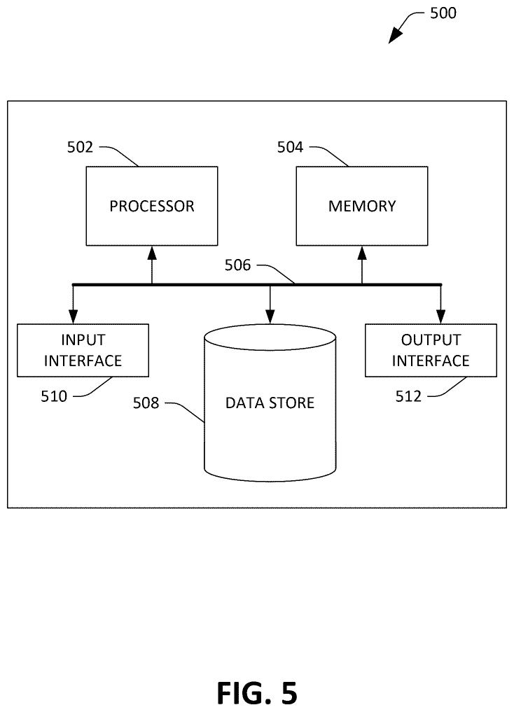

Referring now to FIG. 5, a high-level illustration of an example computing device 500 that can be used in accordance with the systems and methodologies disclosed herein is illustrated (e.g., computing device 102). The computing device 500 includes at least one processor 502 that executes instructions that are stored in a memory 504. The instructions may be, for instance, instructions for implementing functionality described as being carried out by one or more components discussed above or instructions for implementing one or more of the methods described above. The processor 502 may access the memory 504 by way of a system bus 506.

The computing device 500 additionally includes a data store 508 that is accessible by the processor 502 by way of the system bus 506. The data store 508 may include executable instructions, computer-readable text that includes words, etc. The computing device 500 also includes an input interface 510 that allows external devices to communicate with the computing device 500. For instance, the input interface 510 may be used to receive instructions from an external computer device, from a user, etc. The computing device 500 also includes an output interface 512 that interfaces the computing device 500 with one or more external devices. For example, the computing device 500 may display text, images, etc. by way of the output interface 512.

It is contemplated that the external devices that communicate with the computing device 500 by way of the input interface 510 and the output interface 512 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 500 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 500 may be a distributed system. Thus, for instance, several devices may be in communication by way of a network connection and may collectively perform tasks described as being performed by the computing device 500.

The present disclosure relates to hardware acceleration of generative models according to at least the following examples:

(A1) In one aspect, some embodiments include a method (e.g., 400) executed by a processor (e.g., CPU 104, GPU 110, NPU 118, etc.) of a computing system (e.g., computing system 102). The method comprises determining a maximum value for a functional computation based upon a data precision format. The method further comprises determining a minimum value for the functional computation based upon the data precision format. The method additionally comprises modifying an input value for the functional computation to reduce the size of the input value by N bits, wherein N is a positive integer. The method further comprises performing the functional computation based upon the modified input value, the minimum value, and the maximum value. The method additionally comprises responsive to a generative model receiving the input, obtaining a value for the functional computation to be used during generation of the output of the generative model.

(A2) According to some embodiments of the method of A1, performing the functional computation comprises generating a lookup table, wherein the lookup table comprises an array of output values for the functional computation.

(A3) According to some embodiments of any of the methods of (A1)-(A2), obtaining the value for the functional computation to be used during generation of the output of the generative model comprises extracting the value from a lookup table.

(A4) According to some embodiments of any of the methods of (A1)-(A3), the maximum value for the functional computation is an input value that would result in an output value of the functional computation that results in a special repeated value (e.g., negative infinity, zero, or positive infinity) of the functional computation for input values that exceed the maximum value. In some examples, the maximum value exceeds the largest value represented by the data precision format.

(A5) According to some embodiments of any of the methods of (A1)-(A4), the minimum value for the functional computation is an input value that results in the output of a special repeated value (e.g., negative infinity, zero, or positive infinity) of the functional computation for input values that are less than the minimum value. In some examples, the minimum value is an input value that would result in an output value of the functional computation that is equal to or less than half of the smallest value represented by the data precision format.

(A6) According to some embodiments of any of the methods of (A1)-(A5), the functional computation is an exponential function.

(A7) According to some embodiments of any of the methods of (A1)-(A6), the generative model is an LLM.

(A8) According to some embodiments of any of the methods of (A1)-(A7), modifying the input value for the functional computation comprises assigning a fixed value to N bits.

(A9) According to some embodiments of any of the methods of (A1)-(A8), N is selected based upon an accuracy tolerance of the generative model.

(A10) According to some embodiments of any of the methods (A1)-(A9), the generative model is executed according to instructions stored in the memory comprising at least one of a shared system memory, a dedicated graphics processing unit (GPU) memory, or a dedicated neural processing unit (NPU) memory, and wherein the instructions are executed by the at least one processor comprising at least one of a central processing unit (CPU), GPU, or NPU.

(B1) In another aspect, some embodiments include a computing system (e.g., computing system 102) that includes one or more processors (e.g., CPU 104, GPU 110, NPU 118, etc.) and memory (e.g., memory 106, GPU memory 112, NPU memory 120, etc.). The memory stores instructions that, when executed by at least one of the one or more processors, cause the one or more processors to perform any of the methods described herein (e.g., any of A1-A13).

(C1) In yet another aspect, some embodiments include a non-transitory computer-readable storage medium that includes instructions that, when executed by at least one processor (e.g., CPU 104, GPU 110, NPU 118, etc.) of a computing system (e.g., computing system 102), cause the at least one processor to perform any of the methods described herein (e.g., any of A1-A13).

Various functions described herein can be implemented in hardware, firmware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. Such computer-readable storage media can include random-access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “module”, “model” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system, comprising:
at least one processor; and
memory storing instructions that, when executed by the at least one processor, cause the at least one processor to execute a generative model, wherein the generative model receives an input and generates an output responsive to the input;
an accelerator module configured to perform compute operations during execution of the generative model, wherein prior to the generative model receiving the input, the accelerator module performs acts comprising:
determining a maximum value for a functional computation based upon a data precision format;
determining a minimum value for the functional computation based upon the data precision format;
modifying an input value for the functional computation to reduce the size of the input value by N bits, wherein N is a positive integer;
performing the functional computation based upon the modified input value, the minimum value, and the maximum value; and
wherein responsive to the generative model receiving the input, obtaining a value for the functional computation to be used during generation of the output of the generative model.

2. The computing system of claim 1, wherein performing the functional computation comprises:
generating a lookup table, wherein the lookup table comprises an array of output values for the functional computation.

3. The computing system of claim 2, wherein obtaining the value for the functional computation to be used during generation of the output of the generative model comprises extracting the value from the lookup table.

4. The computing system of claim 1, wherein the functional computation is an exponential function.

5. The computing system of claim 4, wherein maximum value for the functional computation is an input value that would result in an output value of the functional computation that exceeds the largest value represented by the data precision format.

6. The computing system of claim 4, wherein minimum value for the functional computation is an input value that would result in an output value of the functional computation that is equal to or less than half of the smallest value represented by the data precision format.

7. The computing system of claim 1, wherein the generative model is executed according to instructions stored in the memory comprising at least one of a shared system memory, a dedicated graphics processing unit (GPU) memory, or a dedicated neural processing unit (NPU) memory, and wherein the instructions are executed by the at least one processor comprising at least one of a central processing unit (CPU), GPU, or NPU.

8. The computing system of claim 1, wherein the generative model is a large language model (LLM).

9. The computing system of claim 1, wherein modifying the input value for the functional computation comprises assigning a fixed value to N bits.

10. The computing system of claim 1, wherein N is selected based upon an accuracy tolerance of the generative model.

11. A method, the method comprising:
determining a maximum value for a functional computation based upon a data precision format;
determining a minimum value for the functional computation based upon the data precision format;
modifying an input value for the functional computation to reduce the size of the input value by N bits, wherein N is a positive integer;
performing the functional computation based upon the modified input value, the minimum value, and the maximum value; and
responsive to a generative model receiving the input, obtaining a value for the functional computation to be used during generation of the output of the generative model.

12. The method of claim 11, wherein performing the functional computation comprises:
generating a lookup table, wherein the lookup table comprises an array of output values for the functional computation.

13. The method of claim 12, wherein obtaining the value for the functional computation to be used during generation of the output of the generative model comprises extracting the value from the lookup table.

14. The method of claim 11, wherein the maximum value for the functional computation is an input value that would result in the same output value of the functional computation for input values that exceed the maximum value.

15. The computing system of claim 1, wherein minimum value for the functional computation is an input value that would result in the same output value of the functional computation for input values that are less than the minimum value.

16. The computing system of claim 1, wherein the functional computation is an exponential function.

17. The computing system of claim 1, wherein the generative model is a large language model (LLM).

18. The computing system of claim 1, wherein modifying the input value for the functional computation comprises assigning a fixed value to N bits.

19. The computing system of claim 1, wherein N is selected based upon an accuracy tolerance of the generative model.

20. A non-transitory computer-readable storage medium comprising instructions that, when executed by a processor of a computing system, cause the processor to perform acts comprising:
determining a maximum value for a functional computation based upon a data precision format;
determining a minimum value for a functional computation based upon the data precision format;
modifying an input value for the functional computation to reduce the size of the input value by N bits, wherein N is a positive integer;
performing the functional computation based upon the modified input value, the minimum value, and the maximum value; and
wherein responsive to the generative model receiving the input, obtaining a value for the functional computation to be used during generation of the output of the generative model.
